(19) United States
(12) Patent Application Publication
(10) Pub. No.: US 2004/0056894 A1
(43) Pub. Date: Mar. 25, 2004

(54) System and method for describing and instantiating extensible user interfaces

(76) Inventors: Igor Zaika, Kirkland, WA (US); Kurt B. Jacob, Redmond, WA (US); Matthew R. Labarge, Kirkland, WA (US); Michael P. Crider, Redmond, WA (US); Steven P. Geffner, Bothell, WA (US)

Correspondence Address: Mark A. Watson, Lyon & Harr, Suite 800, 300 Esplanade Drive, Oxnard, CA, 93030, US

(21) Appl. No.: 10/252,068

(22) Filed: Sep. 19, 2002

(51) Int. Cl. G09G 5/00

(52) U.S. Cl. 345/762

(57) ABSTRACT

A “UI producer” is used to automatically instantiate extensible user interface (UI) windows. The automatically instantiated UI windows are based on dynamic definitions of those UI's. These UI definitions, which include descriptions of controls or other elements used to populate one or more UI windows, are read and interpreted by the UI producer prior to rendering the UI windows. In addition, these UI definitions may also define or reference one or more event handlers or “listeners” that are to be associated with particular controls, groups of controls, or entire UI windows so that the controls or UI windows are capable of interacting with an associated application. After reading the UI definitions, the UI descriptions are acted upon to automatically instantiate each UI window using at least one database of predefined controls and custom elements, with automatic layout rules being used to organize controls and elements within each UI window.

### BACKGROUND

1. Technical Field

The invention is related to computer user interfaces, and in particular, to a system and method for describing and storing extensible user interfaces for computer applications, so that the user interfaces are automatically instantiated either at or during application run time.

2. Related Art

Software applications or computer programs are often run or executed in a windowing environment. Such windowing environments include, for example, any of the Windows® operating systems, or any of a number of other conventional windowing environments. Most of these conventional windowing environments commonly provide interactive or non-interactive dialog windows and task panes or the like, often generically referred to as “user interface windows,” or simply “user interfaces,” to both present information and to receive input from a user. Such user interfaces often contain one or more controls, or groups of controls, such controls often including text, icons, or images for informing a user as to the function of the controls.

Examples of typical controls provided within a user interface window include both dynamic and static controls, such as, for example, push buttons, radio buttons, check boxes, edit boxes, text labels, list boxes, etc. For example, a dynamic control, such as a list box, may be placed in any sort of user interface window, such as a “File Open,” a “File Save,” or any other dialog type window, to provide for user input or selection. Such list boxes typically contain a listing of files or documents available to the user for opening or saving. Further, dynamic controls, such as, for example, a “cancel button” also often include text on the button, i.e., the word “Cancel” on the button. Static controls, such as text labels, display organized information, such as, for example, text information, but do not, by themselves, provide for or receive user input.

One conventional method for creating user interface windows typically involves a labor-intensive process whereby every dialog box, task pane, etc., to be used by a particular application or computer program, is laid out by manually specifying precise positions and dimensions of each individual control within each window. These positions and dimensions are typically stored as a set of resource data that is loaded by the operating system or application program whenever a particular user interface window is drawn or rendered. Further, in many cases, such user interface windows are compiled as a part of the application code. Consequently, in the case where the user interface windows are compiled as a part of the software code, the entire application code must be recompiled every time a change is made to any user interface window. Compiling of large applications is often time consuming, and the resulting application must be thoroughly tested for errors or software bugs.

Further, if the text, language, or size of controls associated with such user interface windows is changed, a new layout for the user interface window is often required. This new layout again requires manually specifying precise positions and dimensions of each individual control within a given user interface window. Consequently, when translating a computer application from one language to another, such as, for example, from English to Japanese or German, it is frequently necessary to completely redesign many, or all, of the user interface windows associated with the translated application, as the size of any text associated with the controls of the translated user interface window is usually significantly different than the original text. Therefore, localization of computer applications is often a time-consuming and expensive task.

Therefore, what is needed is a system and method for automatically and dynamically instantiating user interface windows for computer applications. This system and method should allow user interface descriptions to exist either separate from the underlying code of the application software with which it is associated, or included with such source code, as desired. Consequently, where the user interface descriptions exist separately from the associated application code, changes to user interfaces should be accomplished without the need to recompile the underlying application software with which the user interfaces are associated. Further, this system and method should provide for automatic layout and arrangement of the user interfaces. In particular, as the size of individual controls is changed, such as when text associated with such controls is translated to another language, the system and method should automatically resize and reposition those elements within the user interface window.

### SUMMARY

As is well known to those skilled in the art, a user interface, or “UI,” provides interactive or non-interactive dialog windows, task panes, etc., for either or both presenting information and receiving input from a user. Such user interfaces often contain one or more controls, or groups of controls, such as, for example, push buttons, radio buttons, check boxes, edit boxes, text labels, list boxes, etc. A system and method as described herein automatically instantiates extensible user interfaces based on descriptions of those user interfaces. These automatically instantiated user interfaces include any of a number of controls or other elements, such as, for example, text, vector graphics, images, video, animations, and audio. The user interface descriptions define the particular controls or other elements that are to be included in each user interface window, as well as how those controls or other elements are to interact with one or more associated applications. This system is generally referred to herein as a “UI producer.”

In one embodiment, the UI descriptions exist separately from a compiled application with which the user interfaces are to be used. Alternately, these UI descriptions are either integrated with the source code, or included with standard resources used by the application, such as dynamic linked library (DLL) files. Further, in another related embodiment, any desired combination of separate UI descriptions, included UI descriptions, and linked UI descriptions are used for automatically instantiating extensible user interfaces. In additional embodiments, one or more libraries, files, or databases of resources such as, for example, text strings, images, icons, controls, etc., are referenced by the UI descriptions for the purpose of including those resources in the UI descriptions.

In general, in one embodiment, at application run time, the UI producer operates by reading one or more UI definition files or databases which describe controls or other elements to be placed within a particular UI window along with general relationships between the controls or other elements for use in automatically laying out each UI window. In another embodiment, the UI definitions are read at any time prior to rendering the UI window to a user display device. Consequently, in this embodiment, changes to UI definitions occurring during application run time can be used to dynamically change the appearance of UI windows.

In either case, these UI definition or description files or databases may also define one or more event handlers or “listeners” that are to be associated with particular controls, groups of controls, other UI elements, or entire UI windows so that the controls, other UI elements, or UI windows are capable of interacting with the associated application. After reading the user interface descriptions, either at or during application run time, the controls or other elements described by the UI definition files are read from a library or database file of controls and elements, associated with the specified listeners, and then used to automatically instantiate extensible user interfaces.

As noted above, in one embodiment, the user interface descriptions or definition files are separate from the application code with which the user interfaces are intended to be used. Consequently, in this embodiment, the user interfaces are not compiled with the application code. In fact, because the user interface descriptions or definition files are separate from the underlying application code, the user interface descriptions or definition files can be changed at any time prior to running the underlying application, or alternately, at any time prior to displaying the user interface to provide uniquely configured user interface windows which are then automatically instantiated when rendering the user interface windows.

This concept offers several major advantages. For example, changes to any of the user interface windows do not require editing and recompiling of the associated application source code. Consequently, the number of potential errors that may be introduced into an application are dramatically reduced because the application itself is not edited to modify the UI windows associated with that application. Further the use of separate UI definition files serves to allow for a common baseline application source code, regardless of the user interfaces that are associated with that application.

For example, localization of an application, such as by preparing the application for use in any of a number of alternate languages, i.e., English, German, Chinese, Arabic, etc., is accomplished by simply editing one or more of the UI descriptions or definition files while the underlying application source code is identical for each of the alternate languages. Similarly, any desired customization of UI windows associated with a particular application is easily accomplished by simply editing one or more of the UI definition files to add, remove, rearrange, edit any of the controls within one or more of the UI windows, or simply change the look of controls within one or more UI windows. Further, in one embodiment, this capability allows new controls, controls having a different appearance, or any other desired elements, to be added to an application at any time after compiling the application without the need to recompile the application.

Alternately, as noted above, the UI descriptions are included in either the application code itself, or in one or more linked files, such as a DLL file, or other files which are included in the application as the application is compiled, rather than including the descriptions in separate UI definition files. Regardless of where the UI descriptions are located, they are interpreted and treated in the same manner prior to automatic instantiation of the UI windows that they describe.

Further, in another embodiment, dynamic layout of the automatically instantiated user interface windows is accomplished by applying a set of pre-defined dynamic layout rules for rendering the user interface windows for display and use. Note that this automatic layout is applied in accordance with general relationships between the controls or other elements that are described along with the UI definitions for use in automatically laying out each UI window. In addition, in one embodiment, these dynamic layout rules allow for dynamic resizing and repositioning of user interface windows, with a corresponding automatic dynamic adjustment of already rendered user interface windows. Further, in another embodiment, the automatic layout rules allow for the automatic addition or removal of one or more controls or other elements from a displayed UI window based either on user interaction with the UI window, or automatic programmatic interaction with the UI window by one or more active applications.

Note also that in another embodiment, these layout rules are provided in a UI layout rule file or database which is read at the time that the layout for each UI window is determined. The automatic layout for each UI window is then interpreted in light of these rules. Consequently, in one embodiment, the layout rules for any user interface can be changed, edited, or otherwise updated any time prior to, or during, running of the underlying application to provide uniquely configured user interface windows. Again, this is accomplished without the need to modify the underlying application code in any way.

In addition to the just described benefits, other advantages of the UI producer will become apparent from the detailed description which follows hereinafter when taken in conjunction with the accompanying drawing figures.

### DESCRIPTION OF THE DRAWINGS

The specific features, aspects, and advantages of the UI producer will become better understood with regard to the following description, appended claims, and accompanying drawings where:

FIG. 1 is a general system diagram depicting a general-purpose computing device constituting an exemplary system for automatically instantiating extensible user interfaces.

FIG. 2A illustrates an exemplary architectural diagram showing exemplary program modules for automatically instantiating extensible user interfaces.

FIG. 2B illustrates an alternate embodiment of the exemplary architectural diagram of FIG. 2A.

FIG. 3A illustrates an exemplary system flow diagram for automatically instantiating extensible user interfaces.

FIG. 3B illustrates an alternate embodiment of the exemplary system flow diagram of FIG. 3A.

FIG. 4 illustrates an exemplary system flow diagram of a tested embodiment for automatically instantiating extensible user interfaces.

### DETAILED DESCRIPTION OF THE PREFERRED EMBODIMENTS

In the following description of the preferred embodiments of the UI producer, reference is made to the accompanying drawings, which form a part hereof, and in which is shown by way of illustration specific embodiments in which the invention may be practiced. It is understood that other embodiments may be utilized and structural changes may be made without departing from the scope of the present invention.

1.0 Exemplary Operating Environment:

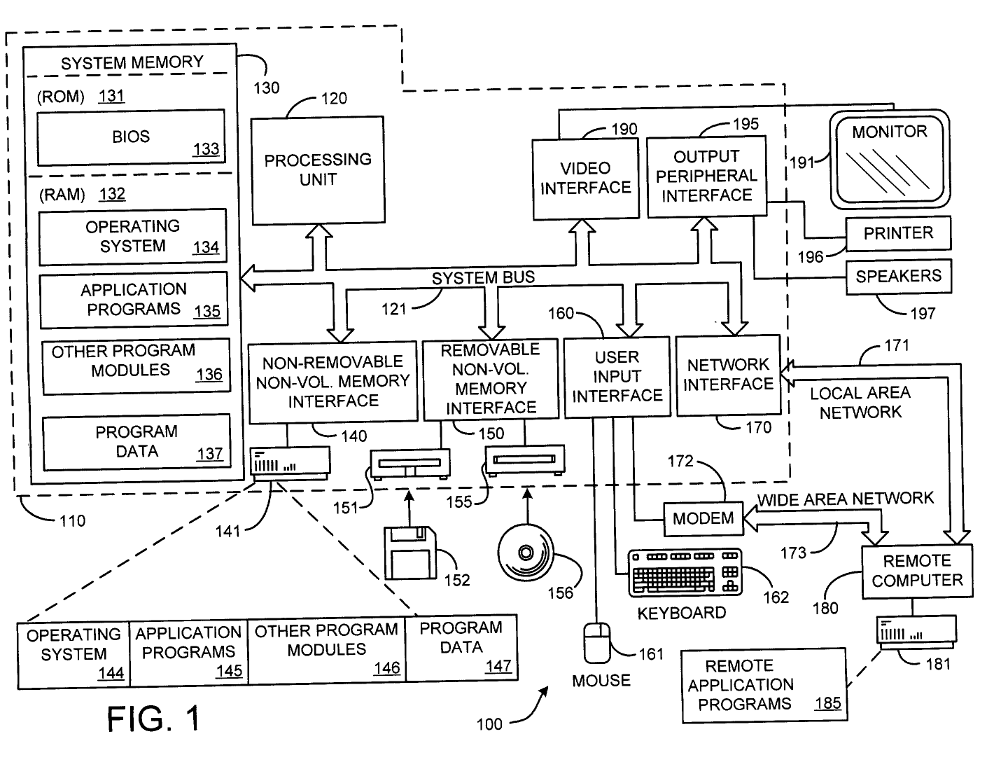

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 1, an exemplary system for implementing the invention includes a general-purpose computing device in the form of a computer 110.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad.

Other input devices (not shown) may include a microphone, joystick, game pad, satellite dish, scanner, radio receiver, or a television or broadcast video receiver, or the like. These and other input devices are often connected to the processing unit 120 through a user input interface 160 that is coupled to the system bus 121, but may be connected by other interface and bus structures, such as, for example, a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining part of this description will be devoted to a discussion of the program modules and processes embodying a system and method for automatically instantiating extensible user interface (UI) windows based on descriptions of those UI's either at or during application run time.

2.0 Introduction:

A “UI producer” as described herein automatically instantiates one or more extensible user interface (UI) windows based on UI window descriptions that are read and interpreted prior to automatically instating the UI windows either at or during application run time. In one embodiment, these UI window descriptions are provided in one or more UI definition files, records, database entries, lookup tables, etc., which are stored separately from an application with which the UI windows are to be used. Alternately, the UI descriptions are included in either the application code itself, or in one or more linked files, such as a DLL file, or in other files which are included in the application as the application is compiled, rather than including the descriptions in separate UI definition files. In additional embodiments, one or more libraries, files, or databases that include resources such as, for example, text strings, images, icons, controls, etc., are referenced by the UI descriptions for the purpose of including those resources in the UI descriptions.

Regardless of whether the UI descriptions are stored separately from the source code, or whether the UI descriptions reference other external resources, the UI descriptions are interpreted and treated in the same manner prior to automatic instantiation of the UI windows that they describe. Note that the aforementioned ability to interpret UI window descriptions during application run time provides the capability to dynamically modify the appearance of particular UI windows while an application is running, without the need to first restart or exit the application.

Each of the automatically instantiated UI windows is comprised of one or more controls or other elements. As is well known to those skilled in the art, a typical UI window provides interactive or non-interactive dialog windows, task panes, etc., for either or both presenting information and receiving input from a user. Such user interfaces often contain one or more controls, or groups of controls, such as, for example, push buttons, radio buttons, check boxes, edit boxes, text labels, list boxes, etc. Additional elements that are included in the UI window, as desired include vector graphics, images, icons, video, animations, and audio. Typically, the UI definition includes properties for each element, including, for example, position, dimension, visibility, text, colors, opacity, borders, accessibility information, enabled state, and other states commonly associated with conventional UI controls.

Further, in one embodiment, custom UI elements are defined for use in the automatically instantiated UI windows. In particular, a custom UI element having any desired properties can be defined for use in one or more applications. These custom elements are then stored in a database, file, DLL, or other resource, in the same manner as conventional elements such as push buttons, radio buttons, check boxes, etc. One example of a custom UI element is an ActiveX object which is created then used as an element within a UI window. However, it should be noted that custom UI elements are not limited to ActiveX objects or controls, and that anything, such as, for example, a group of conventional controls, an image, or video, an audio clip, or even another application can be defined to be a custom UI element. In using a custom UI element in a UI window, the name of any custom element that is to be used in a particular UI window, or a pointer to that custom element, is simply included in the UI definition for that UI window. Custom UI elements are then treated in the same manner as any other element. Consequently, for purposes of explanation, any discussion of UI elements herein will refer to both conventional and custom elements.

Note that the following discussion refers jointly to controls such as, for example, push buttons, radio buttons, check boxes, edit boxes, text labels, list boxes, etc., and to additional elements such as, for example, vector graphics, images, video, animations, audio, and custom UI elements as “UI items,” or “UI elements” except where specific reference is made to particular controls, control types, or other elements.

2.1 System Overview:

The system and method described herein for automatically instantiating extensible user interfaces provides many advantages. For example, because in one embodiment, the user interface descriptions or definition files are separate from the application code with which the user interfaces are intended to be used, the UI producer provides the capability to modify any of the appearance, layout, content and behavior of any UI windows associated with an application without the need to recompile or in any way modify the source code of that application. In fact, because the UI descriptions are separate from the underlying application code in this embodiment, the UI descriptions can be changed at any time prior to or even during running of the underlying application to provide uniquely configured UI windows which are then automatically instantiated at or during application run time.

Further, because changes to any of the user interface windows do not require editing and recompiling of the associated application source code where the definitions are included separately from the application source code, the number of potential errors that may be introduced into an application are dramatically reduced because the application itself is not edited to modify the UI windows associated with that application. In addition, another reason that fewer errors are introduced is because the format for describing the user interface is typically less complicated, and thus easier to edit, than computer source code that would create an equivalent UI. Further, because the UI descriptions are interpreted prior to rendering the associated UI windows, possible errors in the UI descriptions can be filtered out or otherwise automatically addressed prior to rendering the UI window.

In addition, the use of separate UI definition files serves to allow for a common baseline application source code, regardless of the user interfaces that are associated with that application. For example, localization of an application, such as by preparing the application for use in any of a number of alternate languages, i.e., English, German, Chinese, Arabic, etc., is accomplished by simply editing one or more of the UI descriptions or definition files while the underlying application source code is identical for each of the alternate languages. Similarly, any desired customization of UI windows associated with a particular application is easily accomplished by simply editing one or more of the UI definition files to add, remove, rearrange, edit any of the UI items within one or more of the UI windows, or simply to change the look of the UI items within one or more UI windows. Further, in one embodiment, this capability allows new controls, controls having a different appearance, or any other elements to be added to an application UI window at any time after compiling the application without the need to recompile the application. In addition, because the UI definitions are interpreted during application run time in one embodiment, the customization or localization of an application can be accomplished during application run time by simply directing the application to make use of one or more alternate UI definitions.

In general, the UI producer operates either at or during application run time by reading one or more UI definition files which specify the UI items to be placed within a particular UI window and any properties or relationships (e.g., parent-child relationships, etc.) that are to be associated with those UI items. As noted above, in one embodiment, these UI definition files are stored separately from the application with which the UI windows are associated, thereby allowing modification to UI windows associated with an application without the need to edit or recompile application source code. Further, also as noted above, in another embodiment, the UI descriptions are included in either the application code itself, or in one or more linked files, such as a DLL file, or in other files which are included in the application as the application is compiled, rather than including the descriptions in separate UI definition files.

In one embodiment, the UI items specified by the UI definition files are stored in a UI item library or database comprised of predefined controls and other elements, i.e., vector graphics, images, video, etc. Alternately, the UI item library or database contains pointers to some or all of the controls or other elements. This embodiment is useful where elements having a relatively large file size, such as a video clip, are to be included in a rendered UI window. Note that in one embodiment, this database of predefined UI items is editable in order to add or delete controls or other elements, or to change the appearance or behavior of one or more controls or other elements. In addition, the UI definition files may also reference one or more event handlers or “listeners” that are to be associated with particular controls, groups of controls, other elements, or entire UI windows so that the controls, elements, or UI windows are capable of interacting with an associated application. In alternate embodiments, these listeners are either stored in the control database, or in a separate listener file or database.

Once the UI definition files have been read and interpreted, the UI items specified by the UI definition files are then read from the UI item library or database and bound with any specified listeners for interacting with the application. The UI producer then uses these UI items, or item/listener combinations, along with the UI descriptions to automatically instantiate each UI window, with dynamic layout rules being used to automatically organize UI items within each UI window in accordance with any predefined relationships between those UI items.

As noted above, dynamic layout of the automatically instantiated UI windows is accomplished by applying a set of pre-defined dynamic layout rules in combination with pre-defined control relationships for rendering the UI windows for display and use. In addition, in one embodiment, these dynamic layout rules allow for dynamic resizing and repositioning of user interface windows, with a corresponding real-time automatic dynamic adjustment of UI items within already rendered UI windows. In a related embodiment, the automatic layout rules provide for the automatic addition or removal of one or more UI items from a displayed UI window based either on user interaction with the UI window, or automatic programmatic interaction with the UI window by one or more active applications. Again, where UI items are added to or removed from a displayed UI window, there is a corresponding real-time automatic dynamic adjustment of the UI items within that UI window.

Note also that in one embodiment, these layout rules are provided in a UI layout rule file or database which is read at the time that the layout for each UI window is determined. The automatic layout for each UI window is then interpreted in light of these rules. Consequently, in one embodiment, the layout rules for any user interface can be changed, edited, or otherwise updated any time prior to rendering the UI window to provide uniquely configured user interface windows. Again, in one embodiment, this is accomplished without the need to modify the underlying application code in any way.

2.2 System Architecture:

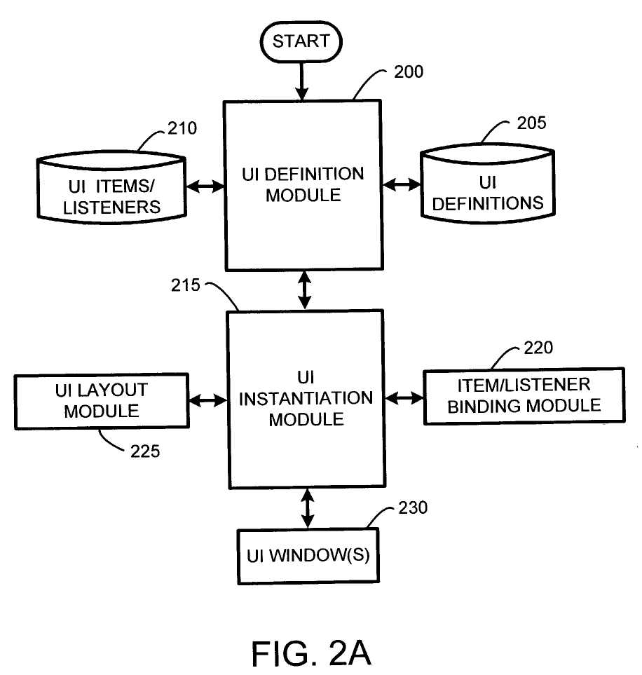

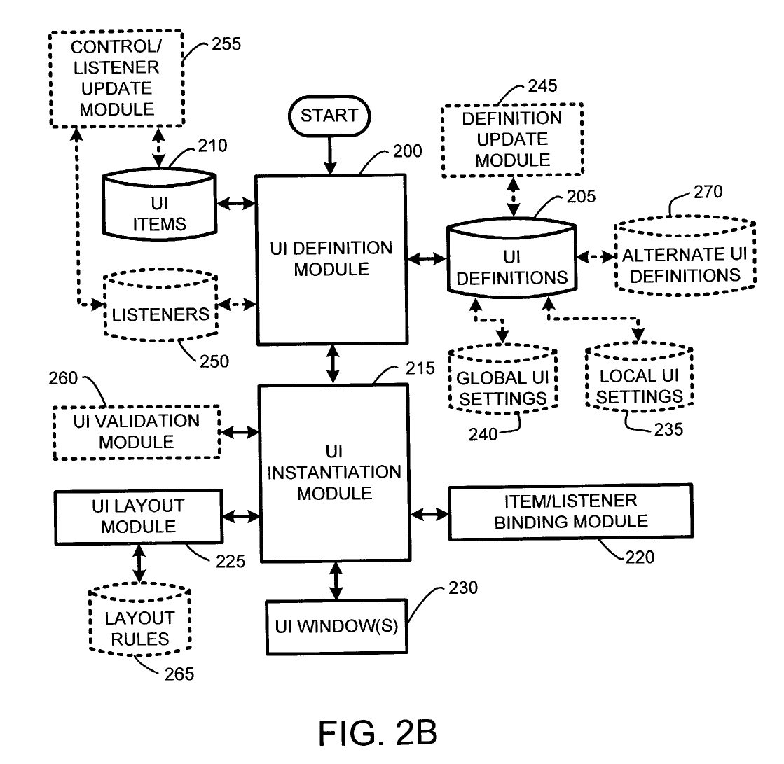

The general system diagrams of FIG. 2A and FIG. 2B illustrate the processes described above. In particular, the system diagrams of FIG. 2A and FIG. 2B illustrate interrelationships between program modules for implementing a “UI producer” for automatically instantiating extensible user interfaces. It should be noted that the boxes and interconnections between boxes that are represented by broken or dashed lines in FIG. 2B represent alternate embodiments of the UI producer, and that any or all of these alternate embodiments, as described below, may be used in combination with other alternate embodiments that are described throughout this document.

In general, as illustrated by FIG. 2A, a system and method for automatically instantiating extensible user interfaces begins at application run time by using a UI definition module 200 to read one or more UI definitions 205 from a file or database, or alternately from definitions included in the application source code, or files otherwise linked to the application source code. Further, because the definitions may change or be updated during application run time, the definitions may be read and interpreted as described herein at any time prior to rendering the UI windows. As noted above, the UI definitions 205 include descriptions of what controls or other elements are to be used in each UI window, what, if any, event handlers or listeners are to be associated with each control or other element, and what, if any relationships exist between controls or other elements in each UI window. Consequently, the UI definition module 200 uses the UI definitions 205 to read the described UI items and listeners 210 from a UI item database or library.

The UI definition module 200 then provides the UI definitions 205, and the UI items and listeners 210 to a UI instantiation module 215. The UI instantiation module 215 then uses a control/listener binding module 220 to bind any UI items and associated listeners, as defined by the UI definitions 205, so that those UI items are capable of interacting with the application for which the UI windows are being generated. A UI layout module 225 then applies a set of predefined UI layout rules, in combination with any predefined relationships between UI items, to automatically lay out each of the UI windows 230, as described in detail in Section 3.5. The UI instantiation module 215 then renders the laid out UI windows to a conventional display device as each UI window is called by the application.

2.2.1 Alternate System Architecture:

A more detailed version of the general system diagram of FIG. 2A is provided as FIG. 2B. In particular, FIG. 2B expands of the general system diagram of FIG. 2A by including a number of alternate embodiments which may be used to enhance the basic UI producer illustrated by FIG. 2A. In particular, as discussed above, and as illustrated by FIG. 2B, the UI producer automatically instantiates one or more UI windows at or during application run time by reading one or more UI definitions 205 into the UI definition module 200. In addition, in further embodiments, these UI definitions 205 include either or both local UI settings 235 and global UI settings 240. These local UI settings 235 and global UI settings 240 are simply read along with the UI definitions 205 either at or during application run time, i.e., at any time prior to rendering the UI window. As far as the UI definition module 200 is concerned, the local and global UI settings, 235 and 240, respectively, are simply a part of the UI definitions 205, and are not treated any differently from the UI definitions.

Local UI settings 235 include any of settings, UI definitions, text strings, and UI item relationships for localizing UI windows for particular locations or languages. For example, after defining the UI windows to be associated with a particular application, the local UI definitions 235 are used in one embodiment to provide alternate text strings and other resources (i.e., controls, strings, icons, bitmaps, etc.) to be used in each of the UI windows for translating those UI windows into another language. In particular, in this embodiment, localization of an application, such as by preparing the application for use in any of a number of alternate languages, such as, for example, English, German, Chinese, Arabic, etc., is accomplished by simply providing local language text strings in each alternate local UI settings file 235.

Further, in this case, when reading the UI definitions 205, the UI definitions simply include a pointer to the local UI settings 235. Therefore, one UI definition file 205 that will work with any number of languages is defined for a given UI window, with the appropriate local UI settings 235 simply being linked to those UI definitions in order to customize the UI window for any desired language. Simply replacing the local UI settings file 235 prior to or during application run time will then serve to automatically customize the automatically instantiated UI windows for whatever language is represented by the local UI settings. Alternately, a group or library of local UI settings 235 covering any number of languages or other settings is provided. Thus, simply editing the UI definitions 205 to call the appropriate local UI setting files 235 will accomplish the same thing as replacing particular local UI setting files with files customized for a particular language. Clearly, such localization settings 235 can be included directly in the UI definitions 205. However, providing the localization settings 235 in separate files allows for easier customization of the UI windows for any given locality.

Note that the local UI settings are not limited to simply localizing particular UI windows for various languages. In fact, the localization settings 235 are used in alternate embodiments for providing other desired customizations to the UI windows. For example, the local UI settings 235 can be used for changing fonts, font sizes, colors, backgrounds, borders, button styles, button shapes, etc., for one or more UI windows. Again, these changes can be applied either at, or during, application run time. Further, in a related embodiment, a database or library of customized local UI files 235 is provided for user selection for changing the look and feel of the UI windows for a given application by simply specifying which local UI file is to be used in combination with the UI definitions 205 for a particular application.

Similarly, global UI settings 240 are provided in another embodiment for setting global parameters to be associated with the UI windows for a given application. Where the local UI settings 235 are applied on a per UI window basis, the global UI settings 240 are applied to all UI windows generated by the UI producer for a particular application. As with the local UI settings 235, the global UI settings 240 may include the same type of settings, UI definitions, language strings, and UI item relationships as described above for the local UI settings. Further, as with the local UI settings 235, simply replacing the global UI settings file 240, or alternately, calling a particular global UI settings file from a database or library of global UI setting files prior to, or during, application run time will then serve to automatically customize the automatically instantiated UI windows based on the settings and parameters specified by the global UI settings.

In a related embodiment, a definition update module 245 is provided for updating or customizing any of the UI definitions 205, the local UI settings 235, and the global UI settings 240. The definition update module 245 simply provides access to existing UI definitions 205, local UI settings 235, and global UI settings 240 for editing or modifying those definitions and settings in any way desired. In particular, simply editing one or more of the UI definitions 205 or the local or global settings, 235 or 240, respectively, serves to accomplish any or all of customizing UI windows for a particular locality or language, adding, removing, rearranging, or editing any of the UI items within one or more of the UI windows, changing the look of UI items within one or more UI windows, or adding new UI items or UI items having a different appearance, to an application at any time prior to rendering those UI windows.

In still another related embodiment, any of the UI definitions 205, the local UI settings 235, and the global UI settings 240 are downloadable from a remote server computer to a local client computer for allowing customization of particular application by simply downloading any desired UI definition and setting files. Further, because the UI definitions 205 are interpreted either at or during application run time, dynamic, on the fly, customization or localization of UI windows in a running application is achieved by the UI producer.

Again, as noted above, the UI definitions 205 include descriptions of what UI items are to be used in each UI window and what, if any, event handlers or listeners are to be associated with each UI item. Further, both the local UI settings 235, and the global UI settings 240 may also include descriptions of what UI items are to be used in each UI window and what, if any, event handlers or listeners are to be associated with each UI item. Consequently, the UI definition module 200 uses the UI definitions 205, along with the local and global UI settings, 235 and 240, respectively, to read the described UI items and listeners 210 from the UI item database or library. Note that in an alternate embodiment, the listeners 250 are maintained in a separate file or database from the UI items 210. Maintaining the listeners 250 in a separate file or database is advantageous in that both the UI items 210 and the listeners 250 can be separately maintained or edited in files which are less complicated than a combined item/listener file or database.

In a related embodiment, an item/listener update module 255 is provided for updating or customizing any of the UI items 210 or listeners 250. The item/listener update module 255 simply provides access to existing descriptions of UI items 210 and listeners 250 for editing or modifying those UI items and listeners in any way desired. In particular, the interaction between any UI windows making use of edited UI items 210 or listeners 250, and any application addressed by those UI windows is accomplished by simply editing one or more of the UI items or listeners. Again, changes made to the UI items 210 or listeners 250 which are accomplished prior rendering a given UI window will be reflected in any associated UI windows without the need to recompile the associated application.

After reading the UI definitions 205, along with any local or global UI settings, 235 or 240 respectively, and the UI items 210 and listeners 250, the UI definition module 200 then provides the UI definitions, and the UI items and listeners 210 to the UI instantiation module 215. At this point, in one embodiment, a UI validation module 260 checks for errors or problems with the UI descriptions. Any number of inconsistencies or errors may be tested for by the UI validation module 260. For example, if the text associated with a particular control/listener combination will not fit within the boundaries of the control, as specified in the UI definitions 205, the local UI settings 235, or the global UI settings 240, then the UI validation module 260 will flag that particular control as invalid.

Other potential errors flagged by the UI validation module 260 include checking to see that particular controls or listeners referenced by the UI definitions 205, the local UI settings 235, or the global UI settings 240 are available to the UI instantiation module 215, or whether particular controls or listeners referenced by the UI definitions, local UI settings, or global UI settings are compatible. For example, it may not be appropriate to couple a text input event handler type listener to a tooltip type UI window since such tooltips are not typically designed to accept user input.

In the case that an error or problem is flagged by the UI validation module 260, there are several possible actions which occur in alternate embodiments of the UI producer. In one embodiment, an alternate UI definition 270 is provided for any UI window, control, or other UI item that is found to be invalid. In another embodiment, a warning message is generated by the UI validation module 260 indicating the cause of any identified errors. In yet another embodiment, the UI validation module 260 will halt or stop instantiation of any UI window which is found to be partially or completely invalid. In a related embodiment, the UI validation module 260 will delete or skip any UI items in a UI window which are determined to be invalid. Finally, in still another embodiment, the UI validation module 260 will provide a placeholder, or other error symbol, icon, or image, to the UI validation module 260 for use in place of any invalid UI items. Note that UI validation and error handling is discussed in further detail below in Section 3.4.

Finally, once the UI validation module 260 has validated the UI items to be used in a given UI window, or otherwise addressed invalid UI items as described above, the UI instantiation module 215 then uses the item/listener binding module 220 to bind or associate particular UI items and listeners, as defined by the UI definitions 205, or the local or global UI settings, 235 or 240, respectively, so that those UI items are capable of interacting with the application for which the UI windows are being generated.

The UI layout module 225 then uses a set of predefined UI layout rules, in combination with any pre-defined relationships between those UI items to automatically lay out each of the UI windows 230, as described in detail in Section 3.5. After automatically laying out the UI items for a UI window, that UI window is then rendered to the display device by the UI instantiation module 215 as each UI window is called by the application. Note that in a related embodiment, separate or alternate sets of UI layout rules 265 are provided for customizing or otherwise modifying the behavior of the automatic layout of the UI windows instantiated by the UI producer.

3.0 Operation Overview:

As noted above, the UI producer generally operates by interpreting one or more UI window definitions, binding appropriate controls and listeners, and applying a set of automatic layout rules to specified controls and control/listener combinations to automatically instantiate one or more UI windows in accordance with the UI window definitions. Specific details regarding implementation of the UI producer are provided in the following sections.

3.1 User Interface Definitions:

As noted above, the UI definitions include the include descriptions of what controls or other elements are to be used in each UI window, what, if any, event handlers or listeners are to be associated with each control or other element, and what, if any relationships exist between controls or other elements within a UI window. Again, any number or type of controls or other elements may be included in a UI window. Such controls include, for example, push buttons, radio buttons, check boxes, edit boxes, text labels, list boxes, etc.

In addition to providing for such conventional controls, other elements, including vector graphics, images, video, animations, and audio may be included in the UI definition, as desired, for inclusion in the rendered UI window. These elements are included in any desired UI window in the same manner as described herein for including controls in a UI window. Further, in another embodiment each of these additional elements may be assigned listeners in the same way as listeners are associated with controls, groups of controls, or entire UI windows, as described below. Note that the controls and other elements described herein are referred to jointly as “UI items” for purposes of discussion, except where they are explicitly referred to individually.

Further, as noted above, the UI items within each UI window are defined in a hierarchical tree-type structure, with a parent or root UI item having one or more child UI items, and each child UI item also having, in some cases, one or more siblings or further child UI items, and so on. These relationships are specified in the UI definition file to allow for automatic layout of the UI windows following the layout rules described in detail in Section 3.5.

In a tested embodiment, the UI definitions were written using XML (extensible markup language) for convenience. However, the UI definitions, including any local and global settings, can be written in any computer readable format, from plain text to binary, so long as an appropriate interpreter is provided for reading the UI definitions.

In general, given an XML framework, for example, the UI definitions can be described as consisting of several basic parts: 1) A “definition” part, which defines strings, colors, fonts and font sizes, borders, backgrounds, etc.; 2) A “style sheet” part which provides default values of attributes for controls and other elements within each UI window; and 3) “Elements” which simply describe the UI items, such as controls, graphics, icons, etc., that are presented to a user via the automatically instantiated UI window. However, it should be noted that both the definition and style sheet part of the UI definition are optional. In particular, so long as the particular elements to be included in a particular UI window are described by the UI definition files, the UI producer is capable of automatically instantiating UI windows including those elements. Further, in one embodiment, styles are conditioned on events. For example, a style may be assigned to a particular UI item, such as a pushbutton type control, so that on a conventional “mouseover” type event for that control, the pushbutton changes color. Clearly, any other desired conditional event can be used to trigger any desired conditional style for any desired UI item.

3.1.1 Local UI Settings:

In general, as discussed above, localization of UI windows is accomplished in one embodiment by providing localization settings for changing the language, look, feel, behavior, etc. of particular UI windows. While it is possible to simply provide a complete new set of UI definitions for each locality, it is easier to simply provide a generic set of UI definitions or descriptions that are applicable to all, or most, localities, while providing separate localization details which are included or linked to each of the UI descriptions for any given locality. Further, rather than including all of the resources (i.e., controls, strings, icons, bitmaps, etc.) used by the UI windows in the generic UI descriptions, it is typically more convenient to specify the resources separately from the generic UI files so that the UI files themselves do not need to be localized. However, it should be clear, that in the alternative, both the localization information and resources can be included in the same UI definition files without the need to include or link to separate localization information or resources. One simple approach which is used to address either alternative is to simply check for the existence of separate localization files or information prior to interpreting the UI definition files. If the localization files or information exists, it is used in interpreting the UI definitions; otherwise, the UI definitions are simply interpreted as they are written.

As noted above, in one embodiment, a file or database for applying localization settings to one or more UI windows is provided by the UI producer. As noted above, local UI settings include the same type of information that is included in the generic UI definitions. However, the use of alternate local UI settings serves to uniquely customize UI windows for each alternate local UI setting. Note that such localization can be applied to any number of UI windows associated with an application, up to including effectively swapping out of the entire user interface for a particular application. Further, where the UI definitions are maintained separate from the underlying application code, this UI replacement is accomplished without ever touching the underlying code of the application with which the UI windows are to be used.

With respect to a tested embodiment, these local UI settings were simply provided as an XML style sheet for providing default values of attributes for controls and other elements within each automatically instantiated UI window. For example, localization of an application for a particular local language or dialect is easily accomplished by simply providing local language text strings in each alternate local UI settings file. The appropriate local UI setting file is then used to customize the UI windows for that local language. However, the local UI settings are not limited to simply localizing particular UI windows for various languages. In fact, the localization settings are used in alternate embodiments for providing other desired customizations to the UI windows. Examples of other uses of the local UI settings include changing fonts, font sizes, colors, backgrounds, borders, button styles, button shapes, etc., for one or more UI windows. Again, because the UI definitions can also be interpreted during application run time, such localization can be dynamically applied to UI windows at any time while an application is running.

3.1.2 Global UI Settings:

Global UI settings are similar to local UI settings, with the exception that the global UI settings are applied across multiple UI windows, while the local UI settings are applied to particular UI windows. In particular, the global UI settings are provided in one embodiment for setting global parameters to be associated with the UI windows for a given application. Unlike the local UI settings that are applied on a per UI window basis, the global UI settings are applied to each of the UI windows generated by the UI producer for a particular application.

As with the local UI settings, the global UI settings include information such as UI definitions, language strings, UI item relationships, etc. Further, the global UI settings file is used by simply replacing any existing global UI settings file with the desired global UI settings file so that either at or during application run time, the UI producer will automatically instantiate the UI windows based on the settings and parameters specified by the global UI settings. Alternately, rather than replacing the global UI settings file, a library or database of multiple global UI setting files is provided, with the UI definitions file simply being edited to call the desired global UI settings from the library or database of multiple global UI setting files so that at or during application run time, the UI producer will automatically instantiate the UI windows based on the settings and parameters enumerated by the specified global UI settings file.

3.1.3 UI Definition Updates:

As noted above, any of the UI definitions, the local UI settings, and the global UI settings can simply be edited to provide the desired parameters. Further, conventional XML scripting was used to code each of these description files in a tested embodiment of the UI producer. Consequently, updating these description files is simply a matter of modifying the corresponding XML script to provide the desired modifications to the UI windows.

In particular, depending upon the changes made, simply editing or otherwise modifying the existing UI definitions or the local or global settings, provides the capability to accomplish any or all of customizing UI windows for a particular locality or language, adding, removing, rearranging, or editing any of the UI items within one or more of the UI windows, changing the look of UI items within one or more UI windows, or adding new UI items or UI items having a different appearance, to an application at any time prior to application run time without the need to recompile the application. Further, as noted above, in one embodiment, the updating of any of the UI definitions can also occur during application run time, i.e., after the UI has already been instantiated. In particular, changes can be made to the internal data structures that represent the instantiated UI, and these changes will be then be reflected in the visible UI as it is rendered to the display device. In other words, any UI definition can be updated at any time prior to rendering the UI window described by that UI definition.

3.2 Controls and Other UI Items:

As noted above, the UI producer populates each UI window with one or more controls or other elements in accordance with the UI descriptions provided in the aforementioned UI definition files. These UI windows are then used for either or both presenting information to, and receiving input from a user.

There are a number of controls which may be selected for inclusion in any given UI window, as desired, in order to create UI windows such as interactive or non-interactive dialog windows, task panes, etc. For example, in a tested embodiment of the UI producer the following control types were provided: button controls, hyperlink controls, labels, rich labels, images, check boxes, radio buttons, text boxes, combo boxes, dropdown lists, list boxes, lines, group headings, list views, popup container controls, customizable ActiveX objects, color pickers, progress bars, HTML controls, etc. As noted above, one or more listeners such as event handlers are bound with each control, as appropriate, in order to provide an interface between the automatically instantiated UI windows and one or more application programs. The use of such control types for interacting with applications is well known to those skilled in the art, and will not be described in further detail herein.

In addition to providing for controls such as those noted above, other elements, including vector graphics, images, video, animations, and audio may be included in the UI definition, as desired, for inclusion in the rendered UI window. These elements are included in any desired UI window in the same manner as described herein for including controls in a UI window, including the use of listeners for monitoring events associated with those elements. Note that the use of listeners, for both controls and other elements is described in the following section.

3.3 Listeners:

“Listeners” are a type of event handler which provides a link between the elements of user interface windows and one or more applications. However, the listeners described herein differ from conventional “event handlers” in that the listeners are both customizable and assignable, via the UI definitions and the local and global UI settings, to any desired controls or other UI items for any particular UI windows. In addition, it should be noted that not all UI items are required to have an associated listener. For example, a UI item such as an image displayed in a UI window may be nothing more than a simple image, with no functionality or application interface being provided by that image.

Listeners are designed to receive three general types of events, including “property change events,” “input events,” and “custom events.” Note that the concept of event handlers for intercepting events such as keyboard and mouse inputs, or events from other applications or input devices are well understood by those skilled in the art. Consequently, the following paragraphs will fully describe the idea of associating particular listeners with particular UI items, as implemented with respect to the UI producer, but will not describe in detail the well-known programmatic methods by which event handlers such as listeners actually interface with either operating systems or applications.

Property change events include two cases. First, property change events include notification that a property change is being attempted on a particular control, group of controls, entire UI window, or other UI item. Note also, that in one embodiment, listeners can prevent an attempted property change based on the UI definitions for that particular UI window. Second, the property change events include notification that a property on a particular control, group of controls, other UI items, or entire UI window has successfully been changed. Input events simply include keyboard, mouse, joystick, or other input device events. Custom events are those events which are specific to a particular type of control, e.g., a mouse button “click” event, or any other custom event described by the UI definition for a particular UI window.

As noted above, listeners act as the interfaces between controls, groups of controls, other UI items, or entire UI windows and one or more applications. Each listener is designed to receive particular events, and to pass those events to particular portions of the application code so that the UI windows are capable of interacting with the application. Event types used in a tested embodiment of the UI producer include: keyboard events, mouse movement events, joystick events, mouse button events, mouse button events corresponding to a context menu, keyboard key combination events, keyboard navigation events (arrow keys, Home or End key, tab key, etc.), other pointing device events, item selection events, item selection change events, scrollbar position change events, drag events, and double-click events.

In general, listeners are notified of events occurring at the level of a particular control or other UI item within a particular UI window. Further, listeners are used to take particular action on a particular event, or to modify the flow of events. For example, listeners are capable of, among other things, calling up context menus or launching other UI windows on a mouse button click. Other examples of listener capabilities include creating a dialog handler that handles events of child dialog controls, i.e., the controls within a particular UI window, updating the UI window itself, or translating a user's actions within the UI window into modifications on internal data structure(s).

Note that when a listener is associated with a particular control or other UI item, it can receive not only the events that the UI item fires directly, but also events within a UI window that are fired by other UI items within that UI window. In particular, as noted above, the controls or other UI items within each UI window are defined in a hierarchical tree-type structure, with a parent or root UI item having one or more child UI items, and each child UI item also having, in some cases, one or more child or sibling UI items, and so on. Consequently, the listener attached to a particular UI item is capable of receiving events fired by other UI items within the UI window that are either traveling down from the root UI item to a target UI item, or traveling up from the target UI item back to the root UI item, so long as that listener and its associated UI item are along the same path between the target UI item and the root UI item. Further, in addition to listening to events for particular controls or other UI items, or the children or siblings of those controls or other UI items, listeners can also act as event handlers that handle events on an entire dialog or UI window.

3.3.1 Item/Listener Binding:

The particular listeners that are bound to any given control, group of controls, other UI items, or entire UI window, is described by the UI descriptions which are read at application run time. However, there are a number of ways to bind or “attach” listeners to UI items. For example, one approach to binding listeners is to simply attach one top-level listener at the root object of the control hierarchy of a given UI window. This top-level listener can then listen to property change, input, and custom events from any child element in the control hierarchy as noted above. Further, another approach to binding listeners is to attach the listeners at other levels of the control hierarchy for more localized or specialized event handling. Further, particular listeners may be defined as a controlling dialog/task pane object that “runs” a particular UI window by updating the state and value of UI items at initialization time and when external changes require an update to the UI window, and responds to events coming directly from the UI items to update internal object(s) for which the UI window displays information.

As noted above, listeners are attached or bound to particular UI items in accordance with the UI definitions for each UI window. However, there are two ways in which listeners are bound to particular elements, i.e., either programmatically or declaratively through the UI definition.

With respect to programmatic attachment, listeners are bound by simply passing an application interface pointer for use by a particular control, group of controls, other UI items, or entire UI window. Programmatic attachment is useful in a number of cases. For example, programmatic attachment is useful when it is desired to allow an existing element in the hierarchy of a particular UI window to listen to events from other UI items. Further, programmatic attachment is useful when it is desired to pass additional information, such as, for example, dialog- or application-specific data, to a particular control, group of controls, other UI items, or entire UI window, when the UI window is automatically instantiated.

With respect to declarative attachment, particular listeners are simply specified in the UI definition for a given UI window. These specified listeners are then created at the instantiation of a particular UI window by specifying the name of the listener to be associated with a particular control, group of controls, other UI items, or entire UI window.

As noted above, each listener is capable of receiving or intercepting any event occurring along the path between a target object and a root object for any given UI window. However, in one embodiment, filters are provided so that particular listeners can simply avoid receiving any particular type of event, or events associated with particular UI items. For example, where it is not desirable that a particular listener associated with a particular control receives particular mouse events associated with another UI item, a mouse filter is simply included in the UI definition so that the control simply ignores the mouse events associated with other UI items. Clearly, any desired filter for avoiding the receipt of any particular event or event type can be defined in the UI definition.

In a tested embodiment of the UI producer, defined filter types included the following: a filter for ignoring a notification that a particular listener has been added to a particular UI item; a filter for ignoring a notification that a particular listener has been removed from a particular UI item; a filter for ignoring a notification that particular properties are about to be changed for a particular UI item; a filter for ignoring a notification that particular properties for a particular UI item have been changed; a filter for ignoring a notification of mouse move input events associated with a particular UI item; a filter for ignoring a notification of all mouse events except a mouse move; a filter for ignoring a notification of keyboard input events; filters for ignoring a notification of input events from other input devices; a filter for ignoring a notification of custom events defined for a particular UI item; a filter for ignoring a notification that a particular control, group of controls, other UI item, or entire UI window is being-destroyed; and finally, a composite filter for ignoring notifications of all of the above events.

In a related embodiment, particular listeners associated with a UI item along the path between a target UI item and a root object for any given UI window are set to “consume” particular events, so that subsequent UI items along that path never have the opportunity to receive those consumed events.

In particular, with respect to input and custom events, a listener can be set to “consume” events coming from particular controls, groups of controls, other UI items, or entire UI window, so that elements in the parent hierarchy and listeners on those parents are not notified of the event. However, it should be noted that since each UI item may have multiple associated listeners, when a particular listener associated with a particular UI item consumes an event, listeners which are associated with that same UI item will still receive the consumed event. In other words, consuming an event prevents only listeners that are lower or higher in the control hierarchy from receiving the event, while allowing siblings of the particular UI item to still receive the consumed event.

Similarly, with respect to property change events, a listener can be set to “consume” a “property changing” event. Consuming the event prevents the property change from taking place, so that a particular control, group of controls, other UI items, or entire UI window will keep its original property value and ignore the property change request which was attempted. Further, unlike with consuming events associated with input and custom events, as described above, once a listener associated with a particular control, group of controls, other UI items, or entire UI window consumes a property changing event, other listeners associated with that the same control, group of controls, other UI items, or entire UI window will not be notified of the property change attempt.

3.4 UI Validation:

As noted above, UI validation is used to identify and handle errors or problems resulting from faulty UI definitions, missing controls, etc. In particular, verification of UI definition files, including local and global UI settings, is accomplished when parsing the UI definition files prior to rendering the UI window to generate control/listener combinations, or other UI item/listener combinations. The following discussion provides examples of specific errors and error conditions which are used in one or more embodiments of the UI producer. However, it should be noted that the listed error conditions are not an exclusive or exhaustive list of errors and error conditions possible for use in UI validation, and that other errors or error conditions may be of greater concern in other embodiments of the UI producer. Further, the errors and error conditions, and the handling of those error conditions can be defined on a case-by-case basis, depending upon the particular embodiments of the UI producer.

In general, in the case that an error or problem in the UI definition is identified, there are a number of possible actions which occur in alternate embodiments of the UI producer. For example, in one embodiment, an alternate UI definition is provided for any UI window, control, or other UI item that is found to be invalid or in error. In another embodiment, a warning message is generated that indicates the cause of any identified errors. In yet another embodiment, instantiation of any UI window which is found to be partially or completely invalid is simply halted or stopped. In a related embodiment, any UI items in a UI window which are determined to be partially or completely invalid are simply deleted or skipped. Finally, in still another embodiment, a placeholder, or other error symbol, icon, or image, is provided for use in place of any invalid UI items.

In another embodiment, when parsing the UI definitions, the UI producer will attempt to create as much of the UI window as possible in the face of errors. For example, given this embodiment, if a specified image/icon for a button isn't found, the button will still get created and will still function; however, it will be missing the image or icon specified by the UI definition. All parsing errors, with the exception of unknown attributes result in an error. These errors are then handled in accordance with a set of error handling procedures.

For example, where the parsing error identifies one or more missing files, i.e., images, icons, text strings, etc., referenced in an attribute, that attribute will simply be cleared, and parsing will continue. Another error involves a reference to unrecognized elements. In this case, a warning will be generated during parsing of the UI definitions when the unrecognized elements are encountered. Parsing will continue, but any children of the unknown element will be ignored. With respect to unknown attributes and values, warnings will be generated, but the parsing of the UI definitions will continue. Where conflicting identifications (ID's) are used to identify separate controls or other elements within a UI window, a warning is generated to indicate that the UI definition contains two or more elements that share the same ID. Similarly, where there is a reference to an element ID that doesn't exist, a warning will be generated. Further, if a particular control doesn't have an ID, or its ID is a duplicate of some other ID in the UI definition, then an error exists.

Additional error conditions include bad element types when referring to other elements. In particular, if a UI definition file references an element that is of the incorrect type, the attribute value will simply be ignored, and a warning will be generated. Further, in the case there are conditions defined in style sheets for a particular element (e.g., a button), but there's no default condition specified for that element (i.e., no button style that doesn't have a condition), then a warning is again generated. This particular error condition is designed to catch the case where there's no style defined for an element because any conditional styles defined for the element evaluated to false.

Still other error conditions involve hard-coded sizes, and hard-coded colors. In particular, directly setting size attributes may cause problems for localization and/or accessibility of particular UI windows. Further, because automatic layout rules are used to size and lay out the elements in each UI window, there are very few cases where it is necessary to specify an exact size for a particular UI item. With respect to hard-coded colors for particular UI windows, an error message is generated because it is preferable to simply use a global color style so as to maintain a common UI window theme for particular applications.

3.5 Automatic Layout:

As noted above, the layout of each UI window is accomplished automatically in accordance with a set of predefined UI layout rules in view of the UI definition for each UI window. In general, the UI producer uses dynamically resizable frames within a window of a graphical user interface, such as a dialog window, to automatically lay out elements within that window. In particular, the UI producer automatically and dynamically sizes and positions one or more parent frames in a window of a graphical user interface, as well as one or more other frames, i.e., “child frames” contained or nested within one or more dynamic rows within each parent frame, as the UI window is generated or resized. As indicated above, each parent frame contains one or more child frames. These child frames in turn contain one or more nested child frames, or other elements, including conventional controls, such as, for example, dynamic and static controls, including push buttons, radio buttons, check boxes, edit boxes, text labels, list boxes, etc., or placeholders for other elements, such as, for example, vector graphics, images, video, animations, and audio clips or files.

The UI layout rules include a number of options for laying out UI elements within each UI window. For example, the possible layout options include “horizontal” layout rules, “vertical” layout rules, “horizontal flow” layout rules, “vertical flow” layout rules, “table” layout rules, and “overlap” layout rules. In addition, it should be noted that any of the aforementioned layout options, i.e., the “horizontal” layout rules, “vertical” layout rules, “horizontal flow” layout rules, “vertical flow” layout rules, “table” layout rules, and “overlap” layout rules can be combined in any desired order to make use of any one or more of the layout options for automatically arranging UI items within a UI window.

The aforementioned “horizontal” layout rules provide the capability to automatically arrange UI elements within a single non-wrapping row. Similarly, the “vertical” layout rules provide the capability to automatically arrange UI elements within a single non-wrapping column. The “horizontal flow” layout rules provide the capability to automatically arrange UI elements within one or more horizontally wrapping rows, as discussed in detail below. Similarly, the “vertical flow” layout rules provide the capability to automatically arrange UI elements within one or more vertically wrapping columns. The “table” layout rules simply provide rules for laying out UI items within an m-by-n table. Finally, the “overlap” layout rules provide layout rules for setting UI items at the same starting position within a UI window.

The following paragraphs provide a detailed discussion of the “horizontal flow” layout rules. Note that the behavior of the “horizontal flow” layout rules is extensible to the behavior of the “horizontal,” “vertical,” and “vertical flow” layout rules, such that an understanding of the behavior “horizontal flow” layout rules as described in detail below should provide a clear understanding of the “horizontal,” “vertical,” and “vertical flow” layout rules to those skilled in the art. Consequently, for purposes of clarity, the “horizontal,” “vertical” and “vertical flow” layout rules will not be discussed in further detail below. Further, with respect to the aforementioned “table” layout rules, these rules simply provide for laying out UI items within an m-by-n table, with the items being left, right, or center justified with respect to each other within the table. Consequently, as such techniques are well known to those skilled in the art, the “table” layout rules will not be discussed in further detail below. Similarly, as noted above, the “overlap” layout rules provide layout rules for setting UI items at the same starting position within a UI window. In other words, the “overlap” layout rules simply provide the capability to overlap one or more UI items in a UI window. Consequently, as such techniques are well known to those skilled in the art, the “overlap” layout rules will not be discussed in further detail below.

3.5.1 “Horizontal Flow” Layout Rules:

In order to effectively utilize the area within a given UI window, the width of each row of children within a parent frame is automatically dynamically computed based, in part, on the current width of the UI window and on the size of the contents of the children (controls, text, etc.). Further, the width of each row of children within a parent frame is also programmatically adjusted based on its insetting or indenting due to surrounding or otherwise related dialog elements. Finally, the relative positions of its child (i.e., interior or nested) frames and associated controls or other elements are dynamically computed based on the width of the parent frame and on the widths of the children, rather than using explicitly programmed relative positions.

In other words, particular frames use additional information, other than just the size of their children, to determine their own size. In particular, each frame partially takes its own size from the UI window, which as noted below, may itself be dynamically resized in one embodiment, and then computes its height based on that width with respect to the children within that frame. Specifically, each frame computes its size (i.e., height and width) hierarchically from the controls, or other elements within that frame, up to the overall parent or root window, and then back down to the individual controls or other elements within that frame. In addition, frames are also capable of arranging their child frames and any associated controls, or other elements within that frame, horizontally in a row, and of wrapping them to multiple rows if they cannot all fit in the same row.

Further, additional features of the automatic UI layout rules include the capability to set margins between rows in frames, adjusting the width of rows within a frame, indenting entire frames, or certain rows within a frame, indenting and/or justifying wrapped children (left, right, or center justifying), distributing rows to fill available space within a frame, distributing children within rows, binding children in groups of two or more for controlling how children wrap, determining which row within a frame children are wrapped into, and expanding particular children to fill particular rows. Additionally, the UI layout rules also provide the capability to specify the vertical alignment of child frames within a particular row of a given frame. For example, with respect to such vertical alignment, child frames of different heights that appear in the same row of a particular frame can be top, center, or bottom aligned with respect to each other in their row.

In general, the automatic layout described above is accomplished by first specifying at least one dynamically resizable frame within a conventional hierarchical tree structure for defining an overall parent window. Next, at least one child frame is specified or placed within the parent frame. The size of the parent frame is then automatically computed based on the hierarchical tree structure, beginning with the children within each frame, up to the overall parent window, and then back down to the individual children within each frame. Next, a minimum sufficient number of horizontal rows are instantiated within each parent frame for displaying each of the children within each parent frame. In addition, the children within each parent frame are automatically arranged within the automatically instantiated horizontal rows. This information is then used for automatically laying out and drawing the UI window in accordance with the controls and other elements as provided by the UI definition for each UI window.

The conventional hierarchical tree structure noted above can be described as a logical, hierarchical, description of the window or dialog. This structure is created by dividing the window into regions, which are in turn divided into sub-regions, etc., all the way down to individual controls. This hierarchy is expressed as a “tree of frames,” wherein each frame represents a rectangular region of the window. The root of the tree is a frame encompassing the entire window. Clearly, progressing down the tree, the frames get smaller and smaller, until the frame leaves are reached, with the frame leaves representing areas each occupied either by a single control, or by a group of two or more controls functioning as a single unit.

Such controls, or control groups, i.e., “control frames,” can include any of a number of conventional frame types. Each type of frame that can have multiple children, or each group of controls, also has a built-in “relation,” like vertical or horizontal, specifying how its children are arranged within it. While most controls appear as leaves of the frame tree, a control can also appear in an internal node, such as a group-box (label-box) frame; this kind of frame indicates the rectangle occupied by the actual label box control, yet it also has one or more children—commonly a single vertical frame of other controls, which are contained inside the group-box. Such hierarchical structures are well known to those skilled in the art, and will not be discussed in detail herein.

In a related embodiment, as the size of individual controls, or other elements, associated with a child frame within a parent frame is changed, such as, for example, when text associated with a particular control is changed, the automatic UI layout rules serve to automatically resize and reposition the controls and other elements within the UI window, or within one or more frames within that window, in accordance with the predefined automatic layout rules.

In another embodiment, the UI producer automatically repositions elements within a UI window or frame within the UI window with respect to predefined relationships between such elements by “binding” those elements. For example, where it is desired that two or more consecutive children of a particular parent frame maintain adjacent positioning with respect to each other, such a relationship will be automatically maintained, space permitting, within rows of the parent frame. This will hold true even where it would be possible to more efficiently utilize space within rows instantiated within a flow frame by wrapping children to subsequent rows.

In a further embodiment, particular relationships between children or elements within a frame are emphasized or maintained through use of indenting functionality. This indenting functionality is typically used when children within one or more rows are automatically wrapped to one or more subsequent rows.

3.5.2 Resizing of UI Windows:

In still another embodiment, automatically and dynamically laying out elements within a UI window is performed dynamically in real-time as a window is automatically or manually resized, or when controls or other elements are either added to, or removed from a UI window. For example, where a user resizes a UI window, the elements within the frames in that UI window are automatically resized and repositioned in real-time as the user resizes the window. Thus, the user is able to watch the dynamic layout of the window as the size of the window changes. It should be noted that resizing of windows is a technique well known in the art, and can be accomplished in any number of ways, such as, for example, by selecting and dragging an edge or corner of the window using a conventional computer pointing device.

In a related embodiment, the automatic and dynamic layout of the UI window, and thus the children within any frames within the UI window, is not performed until resizing of the window is completed. In such cases, an outline of the UI window size may be presented to the user as the UI window is resized. Once the resizing is complete, such as, for example, when the user releases a selected edge or corner of the window, the window is then automatically and dynamically laid out and drawn to the screen.

3.6 System Operation:

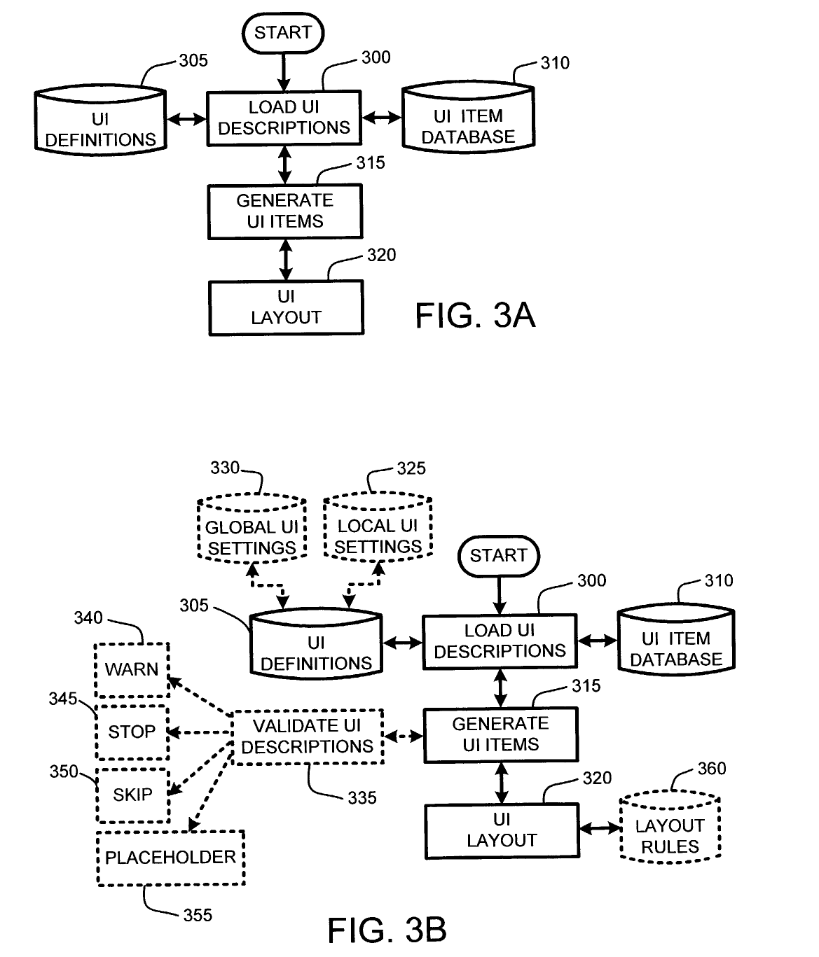

As noted above, the program modules described in Section 2.2 with reference to FIG. 2A and FIG. 2B, and in view of the detailed description provided in Sections 3.1 through 3.5, are employed in a “UI producer” for automatically instantiating extensible user interfaces. This process is depicted in the flow diagrams of FIG. 3A and FIG. 3B. It should be noted that the boxes and interconnections between boxes that are represented by broken or dashed lines in FIG. 3B represent alternate embodiments of the UI producer, and that any or all of these alternate embodiments, as described below, may be used in combination with other alternate embodiments as described throughout this document.

Referring now to FIG. 3A in combination with FIG. 2A and FIG. 2B, the process can be generally described as system for describing UI windows having one or more controls or other elements, and wherein each UI windows is automatically instantiated prior to rendering the UI window, i.e., either at or during application run time, with the description of the UI windows being separate from the underlying application.

In general, as illustrated by FIG. 3A, the UI producer begins by loading UI descriptions 300 from one or more UI definitions files 305. As noted above, the UI definitions 305 include descriptions of what controls or other elements are to be used in each UI window, what, if any, event handlers or listeners are to be associated with each control or other element, and what, if any relationships exist between controls or other elements in each UI window. Based on the descriptions of the controls or other elements to be included in each UI window, is the appropriate UI item and listeners are then loaded from a UI item database or library 310. Once the UI descriptions have been loaded as discussed above, the appropriate controls or other elements 310 are then bound to the appropriate listeners, as specified by the UI definitions 305 in order to generate 315 the UI items that will be used to layout 320 the UI window as described above.

A more detailed version of the general flow diagram of FIG. 3A is provided as FIG. 3B. In particular, FIG. 3B expands of the general flow diagram of FIG. 3A by including a number of alternate embodiments which may be used to enhance the basic UI producer illustrated by FIG. 3A.

In particular, as discussed above, and as illustrated by FIG. 3B, the UI producer automatically instantiates one or more UI windows by first loading 300 one or more UI definitions 305. In addition, these UI definitions 305 are also associated with either or both local UI settings 325 and global UI settings 330. These local UI settings 325 and global UI settings 330 are simply read along with the UI definitions 305, as described above, to create a sort of composite UI definition which includes descriptions of what UI items are to be used in each UI window and what, if any, event handlers or listeners are to be associated with each UI item. Based on the descriptions of the controls or other elements to be included in each UI window, the appropriate UI item and listeners are then loaded from a UI item database or library 310.

Once the UI descriptions have been loaded as discussed above, the UI descriptions are validated, as described in Section 3.4. Further, if any errors are identified by the validation process 335, then an error handler is used to address those errors. In particular, depending upon the particular errors identified when validating the UI descriptions one of several actions occur: 1) In one embodiment, an alternate UI definition is provided for any UI window, control, or other UI item that is found to be invalid or in error; 2) In another embodiment, a warning message 340 is generated which indicates the cause of any identified errors; 3) In yet another embodiment, the instantiation of any UI window which is found to be partially or completely invalid is simply stopped 345 or halted; 4) In a related embodiment, any UI item which is determined to be partially or completely invalid is simply deleted or skipped 350 from the corresponding UI window; and 5) Finally, in still another embodiment, a placeholder 355, or other error symbol, icon, or image is provided for use in place of any invalid UI items.

Next, once the validation step has been completed, the controls or other elements 310 described by the UI definitions are then bound to the appropriate listeners, as specified by the UI definitions 305 in order to generate 315 the UI items that will be used to layout 320 the UI window as described above. Again, binding the listeners to the UI items serves to generate 315 UI items that are capable of interacting with the application for which the UI windows are being generated.

Note that as described above, the automatic layout of the UI items within the UI window is accomplished using a set of pre-defined layout rules 360 in combination with the relationships between any of the UI items within each UI window as described by the UI definitions 305. At this point, the automatically laid out UI window is ready for use in interacting with any associated applications.

4.0 Tested Embodiment:

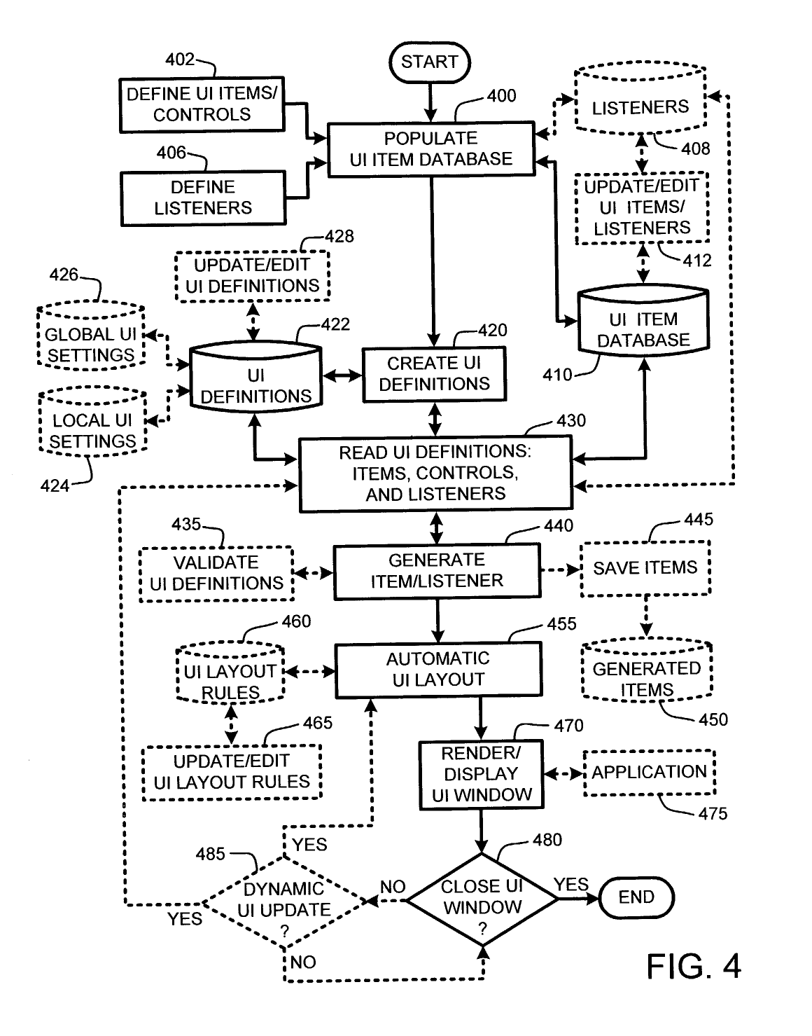

A tested embodiment of the UI producer is illustrated by the exemplary system flow diagram of FIG. 4, as described below. Again, it should be noted that the boxes and interconnections between boxes that are represented by broken or dashed lines in FIG. 4 represent alternate embodiments of the UI producer, and that any or all of these alternate embodiments, as described below, may be used in combination with other alternate embodiments as described throughout this document.

In the tested embodiment of the UI producer illustrated by FIG. 4, the process of automatic instantiation of extensible user interfaces begins by first populating 400 a UI item database 402. Populating 400 this database 402 is accomplished by defining or identifying 404 the UI items, e.g., push buttons, radio buttons, check boxes, edit boxes, text labels, list boxes, etc., and other elements such as, for example, vector graphics, images, video, animations, and audio elements. Further, any listeners or event handlers that are to be used are also identified or defined 406 at this time. Note that in one embodiment, these listeners are stored in the UI item database 402, but that in an alternate embodiment, the listeners 408 are stored in a separate file or database.

In a related embodiment, once the UI item database 402 and listeners 408 have been identified or defined, 404 and 406, those UI items and listeners may be updated or edited 410 as desired. However, once the UI database 402 and listeners 408 have been defined and populated, they may be used for automatically instantiating any number of UI windows without the need to update or edit 410 that information, or to populate other UI databases.

Given the populated UI database 402 and the listeners 408, the next step is to create one or more UI definitions 420, and then to save those definitions to a file or database of UI definitions 422. Note that as described above, the UI definitions can be updated during application run time, so as to provide for dynamic updates to UI windows without the need to restart or exit the running application. As described above, these UI definitions describe controls or other elements to be placed within a particular UI window along with general relationships between the controls or other elements for use in automatically laying out each UI window. In addition, these UI definitions 422 also describe one or more listeners that are to be associated with particular controls, groups of controls, other UI elements, or entire UI windows so that the automatically instantiated UI windows, along with the UI items within those windows are capable of interacting with the application for which those windows were designed. Further, as described above, in one embodiment, the UI definitions 422 are augmented by either or both local UI settings 424 and global UI settings 426.

In a related embodiment, once the UI definitions 422 have been created 420, those UI definitions, along with any local or global UI settings, 424 or 426, respectively, may be updated or edited 428 as desired. However, once the UI definitions 422 have been created, they are reusable any number of times for automatically instantiating UI windows without the need to update or edit 422 that information, or to create new UI definitions.

Given the UI definitions 422 which have been created 420 for use in instantiating the user interfaces, the next step is to read 430 the UI definitions, along with the UI items, controls, and listeners described by those UI definitions. At this point, in one embodiment, the next step is to validate 435 the UI definitions. As discussed above, this UI validation 435 involves identification and handling of errors or problems resulting from faulty UI definitions, missing controls, etc. Further, this validation includes a verification of not only the UI definition files 422, but also a verification of any local and global UI settings, 424 and 426, respectively.

Whether or not the UI definitions 422 have been validated 435, the next step is to generate 440 the control/listener combinations, or other UI item/listener combinations, by binding the appropriate listeners or event handlers with whatever UI items are specified by the UI definitions 422. Once bound, the UI item/listener combination is capable of interfacing with the application. In one embodiment, these generated item/listener combinations are saved 445 to a file or database 450 for later use. Regardless of whether these generated item/listener combinations are saved 445, they are then automatically laid out 455 in accordance with a set of UI layout rules 460, in accordance with any relationships specified between UI items in the UI definitions 422. Note that in one embodiment, the UI layout rules 460 are updateable or editable 465 for the purpose of changing those rules in order to modify the automatic layout of the UI window.

Finally, once the layout 455 has been automatically determined for the UI window, it is rendered 470 to a conventional display device to provide an interface to one or more applications 475. The rendered UI window then persists on the display device until the window is closed 480, or until the window is dynamically updated 485, by either adding or deleting UI items, or resizing the UI window, as described above, at which point, the dynamically updated UI window is again rendered to the display device to provide for user interaction with the application 475.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-readable medium having computer executable instructions for automatically instantiating user interface windows for interacting with at least one application program, comprising:
providing at least one user interface definition, wherein the at least one user interface definition includes a description of any user interface elements and associated event handlers that are to be placed into at least one user interface window for interacting with at least one running application program;
automatically reading and interpreting the user interface definition prior to automatically instantiating the at least one user interface window; and
automatically instantiating the at least one user interface window based on the at least one user interface definition.

2. The computer-readable medium of claim 1 further comprising storing the at least one user interface description separately from the at least one running application program.

3. The computer-readable medium of claim 1 further comprising:
automatically downloading at least one updated user interface definition from a remote server computer; and
automatically instantiating the at least one user interface window based on the at least one updated user interface definition.

4. The computer-readable medium of claim 1 further comprising:
automatically downloading at least one updated user interface definition from a remote server computer while the at least one application program is running; and
automatically instantiating the at least one user interface window based on the at least one updated user interface definition while the at least one application program continues running.

5. The computer-readable medium of claim 1 further comprising dynamically updating at least one of the user interface definitions while the at least one application program is running.

6. The computer-readable medium of claim 3 further comprising automatically instantiating an updated user interface window using the at least one dynamically updated user interface definition while the at least one application program is running.

7. The computer-readable medium of claim 1 wherein the at least one user interface description is read and interpreted at the time that the at least one application program is run.

8. The computer-readable medium of claim 1 further comprising at least one set of layout rules for automatically arranging the user interface elements described by the at least one UI definition when automatically instantiating the at least one user interface window.

9. The computer-readable medium of claim 8 wherein the at least one set of layout rules includes any of “horizontal” layout rules, “vertical” layout rules, “horizontal flow” layout rules, “vertical flow” layout rules, “table” layout rules, and “overlap” layout rules.

10. The computer-readable medium of claim 8 wherein the user interface definition includes a description of general relationships between the user interface elements, and wherein the general relationships are interpreted by the automatic layout rules for automatically arranging the user interface elements.

11. The computer-readable medium of claim 1 wherein the user interface elements include any of button controls, hyperlink controls, labels, rich labels, check boxes, radio buttons, text boxes, combo boxes, dropdown lists, list boxes, lines, group headings, list views, popup container controls, color pickers, progress bars, HTML controls, customizable ActiveX objects, images, vector graphics, animations, video clips, and audio clips.

12. The computer-readable medium of claim 1 further comprising at least one local user interface definition, wherein the at least one local user interface definition provides alternate user interface definitions for the at least one user interface window.

13. The computer-readable medium of claim 12 wherein the alternate user interface definitions represent at least one alternate language to be used in automatically instantiating the at least one user interface window.

14. The computer-readable medium of claim 12 wherein the alternate user interface definitions are used to provide at least one alternate user interface window in at least one alternate language without modifying source code representing the at least one running application program.

15. The computer-readable medium of claim 1 further comprising at least one global user interface definition, wherein the at least one global user interface definition provides common settings to be applied to each of the automatically instantiated user interface windows.

16. The computer-readable medium of claim 1 further comprising at least one set of resource data which is referenced by the at least one user interface definition for including resources represented by the resource data in the at least one automatically instantiated user interface window.

17. The computer-readable medium of claim 1 further comprising automatically validating the at least one user interface definition prior to automatically instantiating the at least one user interface window.

18. The computer-readable medium of claim 1 wherein the user interface definitions are provided in an XML file format.

19. The computer-readable medium of claim 1 wherein the user interface definitions are provided in a binary file format.

20. A system for automatically generating user interface windows for interacting with at least one computer program, comprising:
loading at least one primary user interface description file, wherein the at least one primary user interface description file specifies any of user interface elements to be included in a user interface window, general relationships between the user interface elements, and zero or more event handlers to be associated with particular user interface elements; and
interpreting the at least one primary user interface description file for arranging the at least one user interface elements for at least one user interface window and automatically rendering the at least one user interface window for interfacing with at least one computer program.

21. The system of claim 20 wherein the at least one primary user interface description file is stored separately from compiled source code representing the at least one computer program.

22. The system of claim 20 wherein at least one of the primary user interface description files is automatically downloaded from a remote server computer.

23. The system of claim 20 wherein at least one of the primary user interface description files is updated while the at least one computer program is running.

24. The system of claim 23 further comprising automatically laying out and rendering at least one updated user interface window based on the at least one updated primary user interface description file for interfacing with at least one computer program while the at least one computer program continues to run.

25. The system of claim 20 further comprising at least one alternate user interface description file, said at least one alternate user interface description file including any of at least one localization user interface description file and at least one global user interface description file.

26. The system of claim 25 further comprising loading and interpreting the at least one alternate user interface description file for arranging the at least one user interface elements for at least one user interface window and rendering the at least one user interface window.

27. The system of claim 26 wherein the at least one localization user interface file provides at least one alternate user interface description for localizing at least one user interface window in at least one alternate language.

28. The system of claim 26 wherein the at least one global user interface file provides at least one common setting to be applied to each of the automatically rendered user interface windows.

29. The system of claim 26 wherein any of the at least one primary user interface description file, the at least one localization user interface description file, and the at least one globalization user interface file is updated while the at least one computer program is running.

30. The system of claim 29 further comprising automatically arranging and rendering at least one updated user interface window based on any of the at least one updated primary user interface description file, the at least one localization user interface description file, and the at least one globalization user interface file for interfacing with at least one computer program while the at least one computer program continues to run.

31. The system of claim 25 further comprising binding at least one user interface element with at least one event handler as specified in any of the at least one primary user interface description file, the at least one localization user interface description file and at the least one global user interface description file.

32. The system of claim 20 further comprising at least one set of dynamic layout rules for automatically arranging the user interface elements within each automatically rendered user interface window.

33. The system of claim 32 wherein the at least one set of dynamic layout rules interprets any general relationships between the user interface elements specified in the at least one primary user interface description file for automatically arranging the user interface elements within each automatically rendered user interface window.

34. The system of claim 32 wherein the at least one set of layout rules provides for any of automatic horizontal layout, vertical layout, row-based flow layout, column-based flow layout, table-based layout, and overlapping layout for the user interface elements specified in the at least one user interface description file.

35. The system of claim 32 wherein the at least one user interface windows are resizable.

36. The system of claim 35 further comprising dynamically rearranging the at least one user interface element based on the at least one set of layout rules when the at least one user interface window is resized.

37. The system of claim 20 wherein the at least one user interface elements include any of button controls, hyperlink controls, labels, rich labels, check boxes, radio buttons, text boxes, combo boxes, dropdown lists, list boxes, lines, group headings, list views, popup container controls, color pickers, progress bars, HTML controls, customizable ActiveX objects, images, vector graphics, animations, video clips, and audio clips.

38. The system of claim 20 further comprising at least one set of resource data which is referenced by the at least one primary user interface description file for including resources represented by the resource data in the at least one automatically rendered user interface window.

39. The system of claim 25 further comprising at least one set of resource data which is referenced by the at least one alternate user interface description file for including resources represented by the resource data in the at least one automatically rendered user interface window.

40. The system of claim 20 further comprising automatic error checking of the at least one primary user interface description file for validating the at least one primary user interface description file prior to automatically instantiating the at least one user interface window.

41. The system of claim 25 further comprising automatic error checking of any of the at least one primary user interface description file, the at least one localization user interface description file and the at least one global user interface description file for validating those user interface description files prior to automatically instantiating the at least one user interface window.

42. A computer-implemented process for describing user interface windows, comprising using a computing device to:
create at least one user interface (UI) definition file;
wherein each UI definition file includes descriptions of any UI elements that are to be used in automatically instantiating at least one UI window;
wherein at least one of the UI definition files includes descriptions of any listeners that are to be associated with one or more of the UI elements for providing an interface between the UI elements and one or more computer programs; and
wherein the at least one UI definition file includes descriptions of any parent, child, and sibling relationships between each UI element within each UI window.

43. The computer-implemented process of claim 42 further comprising:
automatically reading and interpreting the at least one UI definition file; and
automatically instantiating the at least one UI window based on the at least one UI definition file.

44. The computer-implemented process of claim 42 wherein the at least one UI definition file includes any of at least one primary UI definition file, at least one localization UI definition file and at least one global UI definition file.

45. The computer-implemented process of claim 44 wherein the at least one localization UI definition file provides at least one alternate UI definition for localizing at least one UI window in at least one alternate language.

46. The computer-implemented process of claim 44 wherein the at least one global UI definition file provides at least one common setting to be applied to each UI window.

47. The computer-implemented process of claim 43 wherein the at least one UI definition file is stored separately from compiled source code representing the one or more computer programs, and wherein the at least one UI definition file is capable of being modified while the one or more computer programs are running.

48. The computer-implemented process of claim 42 wherein at least one of the UI definition files is automatically downloaded from a remote server computer.

49. The computer-implemented process of claim 42 further comprising at least one set of dynamic layout rules.

50. The computer-implemented process of claim 49 wherein the at least one set of dynamic layout rules interprets any general relationships between the UI elements specified in the at least one UI definition file for automatically arranging the UI elements within each automatically instantiated user interface window.

51. The computer-implemented process of claim 49 wherein the at least one set of layout rules provides for any of automatic horizontal layout, vertical layout, row-based flow layout, column-based flow layout, table-based layout, and overlapping layout for the user interface elements specified in the at least one UI definition file.

52. The computer-implemented process of claim 43 further comprising at least one set of dynamic layout rules for automatically arranging the UI elements within each automatically instantiated UI window.

53. The computer-implemented process of claim 52 wherein the at least one UI windows are resizable.

54. The computer-implemented process of claim 53 further comprising dynamically rearranging the at least one UI element based on the at least one set of layout rules when the at least one UI window is resized.

55. The computer-implemented process of claim 42 wherein the at least one UI elements include any of button controls, hyperlink controls, labels, rich labels, check boxes, radio buttons, text boxes, combo boxes, dropdown lists, list boxes, lines, group headings, list views, popup container controls, color pickers, progress bars, HTML controls, customizable ActiveX objects, images, vector graphics, animations, video clips, and audio clips.

56. The computer-implemented process of claim 43 further comprising at least one set of resource data which is referenced by the at least one UI definition file for including resources represented by the resource data in the at least one automatically instantiated UI window.

57. The computer-implemented process of claim 20 further comprising automatic error checking and validation of the at least one UI definition file.
